(19) United States
(12) Patent Application Publication
(10) Pub. No.: US 2024/0112651 A1
(43) Pub. Date: Apr. 4, 2024

(54) HAMMER DEVICE FOR KEYBOARD INSTRUMENT

(71) Applicant: KABUSHIKI KAISHA KAWAI GAKKI SEISAKUSHO, Hamamatsu-shi (JP)

(72) Inventor: Takuma MURAI, Hamamatsu-shi (JP)

(21) Appl. No.: 18/473,062

(22) Filed: Sep. 22, 2023

(30) Foreign Application Priority Data
Sep. 30, 2022 (JP) 2022-157246

(51) Int. Cl. G10C 3/18

(52) U.S. Cl. CPC G10C 3/18

(57) ABSTRACT

A hammer device for a keyboard instrument includes a plurality of hammers. Each hammer has a hammer body extending in a front-rear direction and having a front half thereof pivotally supported and a rear half thereof formed with a weight mounting portion. A first weight common in shape and size to the hammers is attached to one of left and right side surfaces of the weight mounting portion. A second weight is attached to the other of the left and right side surfaces of the weight mounting portion. The first weight includes a stopper contact portion which protrudes at least either more upward or more downward than the second weight, and is brought into contact with a stopper in accordance with pivotal movement of the hammer caused by depression of a key associated therewith.

### BACKGROUND OF THE INVENTION

### Field of the Invention

The present invention relates to a hammer device for a keyboard instrument, which is applied to a keyboard instrument, such as an electronic piano, and is configured to add a touch weight to a key by a hammer pivotally moved in interlock with depression of the key.

### Description of the Related Art

Conventionally, as this type of a hammer device for a keyboard instrument, there has been known, for example, one disclosed in Japanese Laid-Open Patent Publication (Kokai) No. 2015-87591 already filed by the present applicant. This hammer device includes a hammer body extending in a front-rear direction, and two left and right weights mounted on a rear portion of the hammer body in a state sandwiching the rear portion from the left and the right. A common weight as one of the two weights extends in the front-rear direction and is formed to have a shape and a size which are common to all hammers of the keyboard instrument. Further, an adjustment weight as the other of the two weights extends in the front-rear direction and is formed to have a length dimension in the front-rear direction which is not larger than a length dimension in the front-rear direction of the common weight and is set according to a touch weight required for a key associated with the hammer.

The above-described hammer device uses the common weight and the adjustment weight. The common weight and the adjustment weight are formed such that the lengths of the two weights in the front-rear direction are equal to each other or the length of the adjustment weight is shorter than that of the common weight, but such that the heights of the two weights in a vertical direction are formed equal to each other. In general, the key stroke of a key being depressed is determined according to the angle of pivotal movement of an associated hammer which is pivotally moved in interlock with depression of the key until the hammer is brought into contact with a stopper, and hence in a keyboard device to which the above-described hammer device is applied, all the key strokes are equal to each other, which sometimes makes it difficult to adjust the key stroke or the touch weight on a key-by-key basis.

Further, in the above-described hammer device, when a hammer is pivotally moved in accordance with depression of a key associated therewith, the two weights, i.e., the common weight and the adjustment weight of the hammer are sometimes brought into contact with stoppers, such as cushions. In this case, noise is sometimes generated since the contact areas of the weights with the stoppers are relatively large.

### SUMMARY OF THE INVENTION

It is an object of the present invention to provide a hammer device for a keyboard instrument, which enables a key stroke and a touch weight at the time of key depression to be adjusted with ease and makes it possible to suppress generation of noise when a hammer is brough into contact with a stopper.

To attain the above object, the present provides a hammer device for a keyboard instrument, which includes a plurality of hammers each provided in association with an associated one of a plurality of keys, and in which each of the hammers is pivotally moved in interlock with depression of the associated key to thereby add a touch weight to the key, wherein each of the plurality of hammers includes a hammer body extending in a front-rear direction, the hammer body having a front half thereof pivotally supported and a rear half thereof formed with a weight mounting portion, a first weight extending in the front-rear direction, the first weight being formed common in shape and size to the plurality of hammers, and attached to one of left and right side surfaces of the weight mounting portion, and a second weight extending in the front-rear direction and attached to the other of the left and right side surfaces of the weight mounting portion, wherein the first weight includes a stopper contact portion protruding at least either more upward or more downward than the second weight, for being brought into contact with a stopper in accordance with pivotal movement of the hammer caused by depression of the key associated therewith.

According to this construction, each of the plurality of hammers has the hammer body and the first and second weights all of which extend in the front-rear direction, and for the hammer body which has the front half thereof pivotally supported, the first and second weights are attached to the respective left and right side surfaces of the weight mounting portion formed on the rear half of the hammer body. Further, the first weights of the respective hammers are formed identical in shape and size to each other. By attaching the above-described first and second weights to the hammer body of each hammer, e.g. in a case where a length dimension of the second weight in the front-rear direction is set to be equal to or shorter than that of the first weight, it is possible to secure not less than half of weight required for the hammer using the first weight and easily adjust the weight required for the hammer using the second weight.

Further, the first weight is provided with the stopper contact portion protruding at least either more upward or more downward than the second weight. Out of the hammer pivotally moved in interlock with depression of the key, the stopper contact portion of the first weight is brought into contact with the stopper. With this, compared with e.g. a case where both of the first and second weights are brought into contact with the stopper, it is possible to reduce an area brought into contact with the stopper, whereby it is possible to suppress generation of noise when the hammer is brought into contact with the stopper. Further, by adjusting the height of the stopper contact portion, it is possible to change timing at which the hammer is brought into contact with the stopper, whereby it is possible to adjust a key stroke of the key.

Preferably, the second weight has a length dimension in the front-rear direction set according to a touch weight required for the associated key.

According to the construction of this preferred embodiment, since the weight of the second weight can be changed by changing the length dimension of the second weight in the front-rear direction, it is possible to easily adjust a touch weight required for the associated key using the total weight of the first and second weights.

The above and other objects, features, and advantages of the present invention will become more apparent from the following detailed description taken in conjunction with the accompanying drawings.

### BRIEF DESCRIPTION OF THE DRAWINGS

FIGS. 1A and 1B are perspective views of a part (one octave section) of a keyboard device for an electronic piano to which the present invention is applied, in which FIG. 1A shows the appearance of the keyboard device and FIG. 1B shows a state in which keys other than a white key and a black key at a left end of the keyboard device are omitted;

FIG. 2 is a perspective view of the keyboard device shown in FIG. 1B in a state in which the white key and the black key are removed, together with respective key support mechanisms therefor, from a keyboard chassis;

FIG. 3A is a plan view of the keyboard device from which the keys other than the white key and the black key at the left end of the keyboard device are omitted and FIG. 3B is a cross-sectional view taken along line A-A of FIG. 3A;

FIGS. 4A and 4B are perspective views of the white key and the key support mechanism therefor, in which FIG. 4A shows the white key and the key support mechanism in a connected state and FIG. 4B shows the white key and the key support mechanism in an exploded state;

FIGS. 5A and 5B are perspective views of the black key and the key support mechanism therefor, in which FIG. 5A shows the black key and the key support mechanism in a connected state and FIG. 5B shows the black key and the key support mechanism in an exploded state;

FIGS. 6A and 6B are views useful in explaining operation of the white key in the keyboard device, in which FIG. 6A shows a key-released state and FIG. 6B shows a key-depressed state;

FIGS. 7A and 7B are views useful in explaining operation of the black key in the keyboard device, in which FIG. 7A shows a key-released state and FIG. 7B shows a key-depressed state;

FIGS. 8A and 8B are views of a first arm, in which FIG. 8A is a perspective view of the appearance of the first arm and FIG. 8B is an exploded perspective view of the first arm in a state in which an arm body and two weights are separated from each other;

FIG. 9 is a side view of a common weight and an adjustment weight in a horizontally aligned state, in which (a) shows the adjustment weight and (b) shows the common weight; and

FIG. 10 is a side view of the common weight and a plurality of adjustment weights in a vertically aligned state, in which (a) shows the common weight and (b) to (e) show the adjustment weights different in length from each other.

### DETAILED DESCRIPTION OF PREFERRED EMBODIMENTS

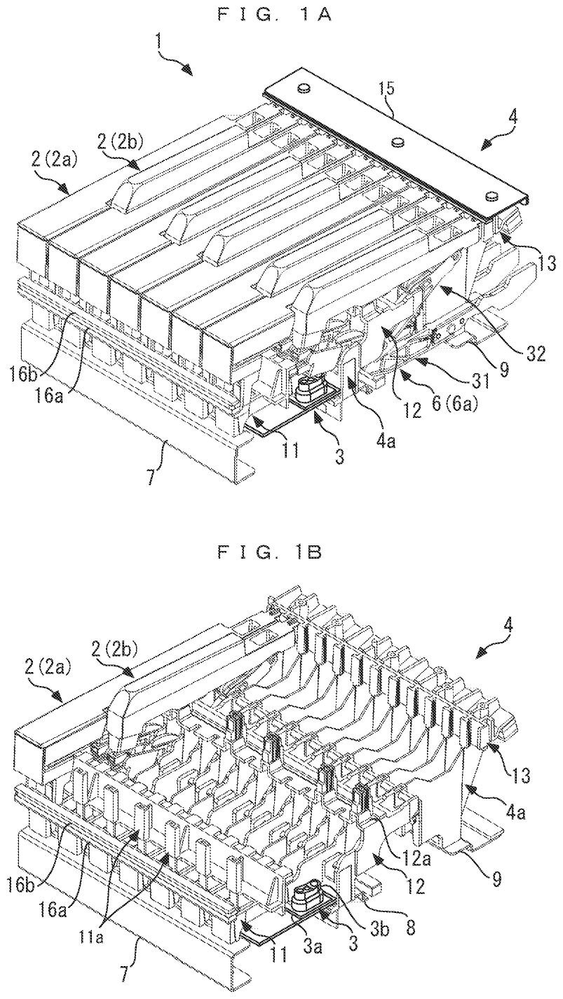

The present invention will now be described in detail with reference to the drawings showing preferred embodiments thereof. FIG. 1A shows only one octave section of a keyboard device 1 for an electronic piano to which the present invention is applied. Note that in the following, a description will be first given of the basic construction of the keyboard device 1 and operation thereof, and then of an essential part of the present invention.

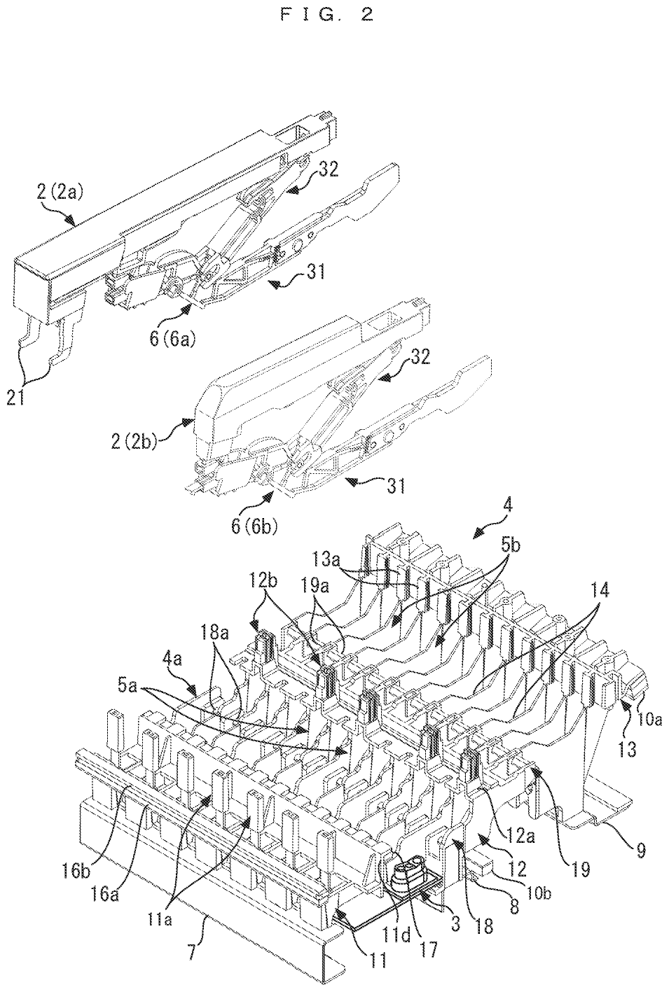

FIG. 1B shows a state of the keyboard device 1 shown in FIG. 1A, in which keys 2 other than a white key 2a and a black key 2b at the left end of the keyboard device 1 are omitted. FIG. 2 shows a state of the keyboard device 1 shown in FIG. 1B, in which the white key 2a and the black key 2b are removed, together with respective key support mechanisms 6 therefor, from a keyboard chassis 4.

This keyboard device 1 is comprised of the keyboard chassis 4, the plurality of keys 2 including the white keys 2a and the black keys 2b and arranged side by side in a left-right direction, a plurality of key support mechanisms 6 each pivotally mounted on the keyboard chassis 4, for supporting an associated one of the keys 2 from below, and key switches 3 each for detecting key depression information of an associated one of the keys 2.

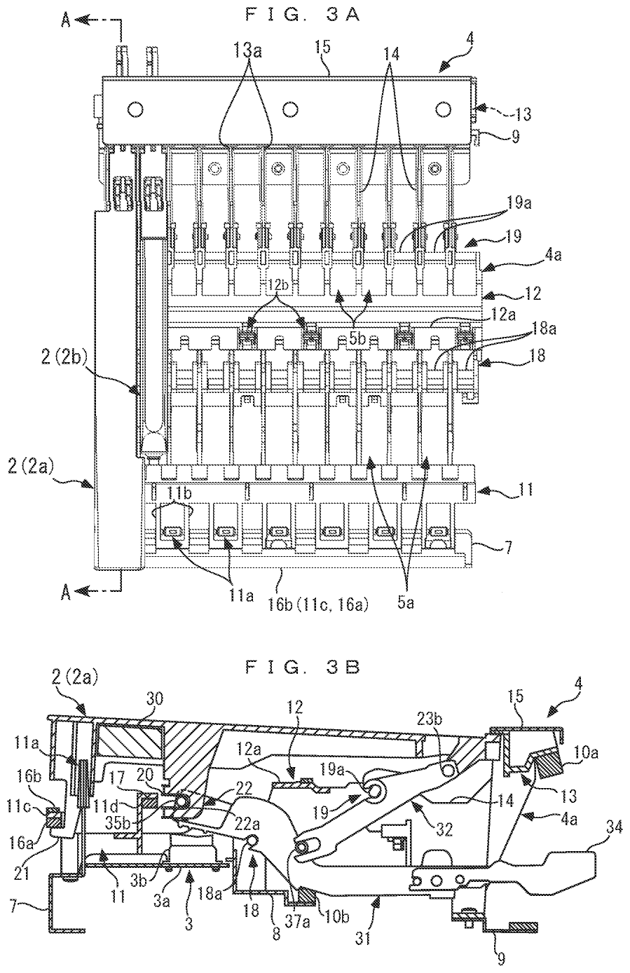

The keyboard chassis 4 includes a chassis body 4a formed as a resin molded article which is made e.g., by injection molding of a predetermined resin material (e.g., an ABS resin) into a predetermined shape. As shown in FIGS. 3A and 3B, the chassis body 4a has a front portion 11, an intermediate portion 12, and a rear portion 13, each extending in the left-right direction (in a left-right direction in FIG. 3A) as a whole. The front portion 11, the intermediate portion 12, and the rear portion 13 are integrally formed with each other via a plurality of ribs 14 disposed with a spacing therebetween in the left-right direction and each extending in the front-rear direction. Note that in the following description, the front portion 11, the intermediate portion 12, and the rear portion 13 of the chassis body 4a of the keyboard chassis 4 will be referred to as “the chassis front 11”, “the chassis intermediate 12”, and “the chassis rear 13”, respectively.

The chassis front 11 is mainly for guiding the white key 2a during depression thereof and restricting the upper limit position and the lower limit position of a front end of the white key 2a. On the chassis front 11, there are erected a plurality of white key guides 11a, each of which is inserted into each associated one of the white keys 2a from below so as to prevent lateral swing of the white key 2a, in a state arranged side by side in the left-right direction. Further, the chassis front 11 has engagement holes 11b and lib, vertically extending therethrough, which are formed on the left and right sides of each of the white key guides 11a, respectively. A pair of left and right upper limit position regulation portions 21 and 21, referred to hereinafter, of the white key 2a are engaged with the respective engagement holes 11b and 11b in a state inserted therethrough. Furthermore, the chassis front 11 has a front end thereof formed with a stopper-mounting portion 11c that protrudes forward and extends along the entirety of the chassis body 4a in the left-right direction. A key upper limit stopper 16a and a key lower limit stopper 16b for the white key 2a are mounted on a lower surface and an upper surface of the stopper-mounting portion 11c, respectively, such that they extend in the left-right direction. Note that a stopper-mounting portion 11d for the black key, which extends along the entirety of the chassis body 4a in the left-right direction, is provided at a predetermined location of the chassis front 11, rearward of each white key guide 11a, and a key upper limit stopper 17 for the black key is mounted on the stopper-mounting portion 11d such that it extends in the left-right direction.

The chassis intermediate 12 is mainly for guiding the black key 2b during depression thereof and swingably supporting a first arm 31 and a second arm 32, described hereinafter, of each of a white key-associated key support mechanism 6a and a black key-associated key support mechanism 6b. The chassis intermediate 12 has a flat portion 12a in the form of a flat plate extending in the left-right direction, and a plurality of black key guides 12b erected on the flat portion 12a and disposed with an appropriate spacing therebetween in the left-right direction. Each black key guide 12b is inserted into an associated one of the black keys 2b from below to prevent lateral swing of the black key 2b. Further, the chassis intermediate 12 has a front portion thereof provided with a first arm support portion 18 for supporting the first arms 31 of the key support mechanisms 6. The first arm support portion 18 has a plurality of first pivot shafts 18a each of which is provided between each adjacent two of the ribs 14 and 14 such that the first pivot shaft 18a extends in the left-right direction. The first arms 31 are swingably supported on associated ones of the first pivot shafts 18a. Furthermore, the chassis intermediate 12 has a rear portion thereof provided with a second arm support portion 19 for supporting the second arms 32 of the key support mechanisms 6. The second arm support portion 19 has a plurality of second pivot shafts 19a each of which is provided between each adjacent two of the ribs 14 and 14 such that the second pivot shaft 19a extends in the left-right direction. The plurality of second pivot shafts 19a are arranged on the same axis extending in the left-right direction at a location rearward of and higher than the first pivot shafts 18a, and the second arms 32 are swingably supported on associated ones of the second pivot shafts 19a. Note that a first arm lower limit stopper 10b extending along the entirety of the chassis body 4a in the left-right direction is provided at a predetermined location of a middle rail 8, referred to hereinafter, provided below the chassis intermediate 12.

Further, the above-mentioned key switches 3 are mounted on a lower portion of the keyboard chassis 4 between the above-described chassis front 11 and chassis intermediate 12. The key switches 3 are formed by a laterally elongated printed circuit board 3a extending in the left-right direction, and a plurality of switch bodies 3b formed by rubber switches attached to the printed circuit board 3a on a key-by-key basis, for being pressed by associated ones of the first arms 31 upon key depression.

The chassis rear 13 is mainly for guiding the keys 2 by their rear ends in the vertical direction while preventing lateral swing of the keys 2 and for restricting the upper limit positions of the rear ends of associated ones of the first arms 31. As shown in FIGS. 2 and 3A, the chassis rear 13 has a plurality of partition walls 13a formed with a predetermined spacing therebetween in the left-right direction so as to separate each adjacent two of the keys 2 and 2 from each other. Further, as shown in FIG. 3B, a first arm upper limit stopper 10a extending along the entirety of the chassis body 4a in the left-right direction is provided at a predetermined location of an upper portion of the chassis rear 13. The first arm upper limit stopper 10a and the first arm lower limit stopper 10b provided on the chassis intermediate 12 are for restricting the upper limit position and the lower limit position of the first arm 31, respectively, when the first arm 31 having a function as a hammer for adding a touch weight to the key 2 pivotally moves upward and downward. Furthermore, a metal cover plate 15 extending in the left-right direction along the entirety of the chassis body 4a and disposed to cover the rear ends of the keys 2 is mounted on the upper portion of the chassis rear 13.

As shown in FIGS. 2 and 3A, the chassis body 4a of the keyboard chassis 4 constructed as described above is formed with a plurality of first openings 5a open upward and forward and a plurality of second openings 5b open upward. The first arms 31 of the key support mechanisms 6 are engaged with associated ones of the first pivot shafts 18a from outside via the above-mentioned first openings 5a, respectively. Further, the second arms 32 are engaged with associated ones of the second pivot shafts 19a from outside via the above-mentioned second openings 5b, respectively.

Further, in the above-described keyboard chassis 4, a plurality of chassis bodies 4a are connected to each other in a state arranged side by side in the left-right direction, and are each screwed to a front rail 7, the middle rail 8, and a rear rail 9 in a state placed thereon, the rails 7, 8 and 9 each extending in the left-right direction and arranged with a predetermined spacing therebetween in the front-rear direction. The keyboard chassis 4 is fixed to a keybed, not shown, of the electronic piano via the front rail 7 and the rear rail 9.

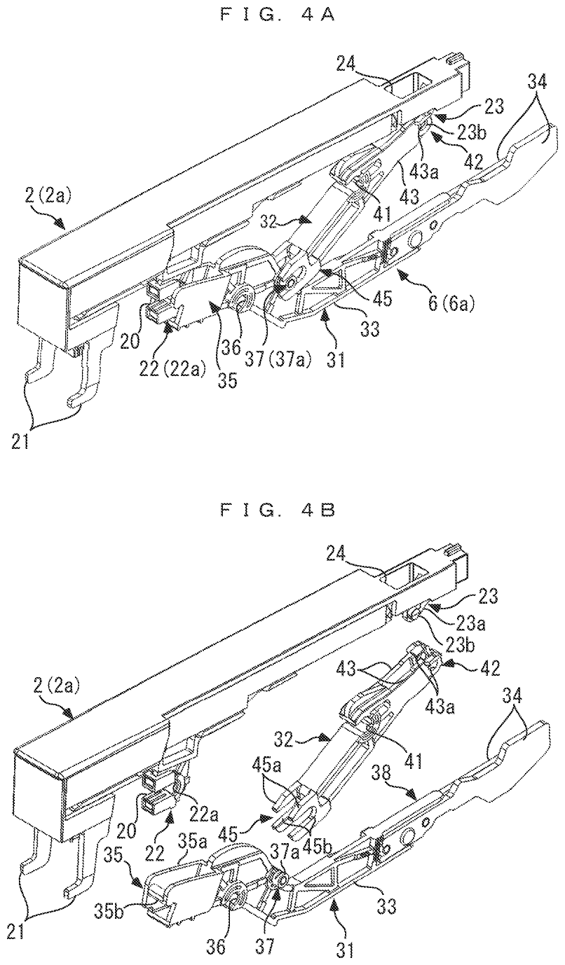

Next, the keys 2 and the key support mechanisms 6 will be described. FIG. 4A shows the white key 2a and the key support mechanism 6a therefor on an enlarged scale, and FIG. 4B shows them in an exploded state. As shown in FIGS. 4A and 4B, the white key 2a is formed into a hollow shape which extends a predetermined length in the front-rear direction and opens downward e.g., by injection molding of a predetermined resin material (e.g., an AS resin). The white key 2a has the front end thereof formed with the pair of left and right upper limit position regulation portions 21 and 21 which protrude downward from respective side walls of the front end of the white key 2a and each having a lower end thereof bent forward. As described hereinabove, the left and right upper limit position regulation portions 21 and 21 are engaged with the respective left and right engagement holes 11b and 11b of the chassis front 11 in a state inserted therethrough.

Further, at a predetermined location of the front portion of the white key 2a, rearward of the upper limit position regulation portions 21, there is provided a key front-side connecting portion 22 connected to the first arm 31 of the key support mechanism 6a. This key front-side connecting portion 22 includes a connecting recess 22a which has a U shape having a slot-like shape in side view and open forward. Further, the connecting recess 22a has a cushioning member 20 attached thereto, which is formed to cover the whole inner peripheral surface of the connecting recess 22a, for suppressing generation of noise when a connecting shaft 35b, referred to hereinafter, of the first arm 31 slides in the inner peripheral surface of the connecting recess 22a. Note that in the front portion of the white key 2a, between the above-mentioned upper limit position regulation portions 21 and key front-side connecting portion 22, there is mounted a keyboard-associated weight 30 (see FIG. 3B) for adding a touch weight to the white key 2a during depression thereof.

Furthermore, the white key 2a has a rear portion thereof provided with a key rear-side connecting portion 23 connected to the second arm 32 of the key support mechanism 6a. The key rear-side connecting portion 23 has a plate-like connecting body portion 23a which hangs downward from a laterally central portion of the white key 2a and has a predetermined thickness in the left-right direction, and a pair of left and right engaging protrusions 23b and 23b which coaxially protrude from the left and right side surfaces of the connecting body portion 23a, respectively. Further, the rear portion of the white key 2a is formed with a tool insertion hole 24 which vertically extends through the rear portion, and is used to have a predetermined tool inserted therein from above for disconnecting the white key 2a from the second arm 32 of the key support mechanism 6a e.g., at the time of maintenance of the keyboard device 1.

On the other hand, the key support mechanism 6a includes the first arm 31 and the second arm 32 which are engaged with each other and are connected to the key front-side connecting portion 22 and the key rear-side connecting portion 23 of the white key 2a, respectively.

As shown in FIG. 4B, the first arm 31 is comprised of an arm body 33 and two weights 34 and 34 attached to the arm body 33. The arm body 33 is formed as a resin molded article which is made e.g., by injection molding of a predetermined resin material (e.g., polyacetal resin) into a predetermined shape. This arm body 33 extends a predetermined length in the front-rear direction, and has a front end thereof formed with a first arm front-side connecting portion 35 connected to the key front-side connecting portion 22 of the white key 2a. The first arm front-side connecting portion 35 includes a box portion 35a having a box-like shape open upward and forward, and the connecting shaft 35b provided such that it extends in the left-right direction in a state connecting the front-side upper ends of left and right side walls of the box portion 35a to each other. The connecting shaft 35b is connected to the connecting recess 22a of the key front-side connecting portion 22 of the white key 2a such that the connecting shaft 35b is pivotally movable and is slidable in the front-rear direction.

Further, the arm body 33 has a bearing portion 36 formed at a predetermined location immediately rearward of the first arm front-side connecting portion 35. The bearing portion 36 has an inverted U shape open downward in side view, and is pivotally engaged with the first pivot shaft 18a of the keyboard chassis 4. Furthermore, the arm body 33 has a first arm rear-side connecting portion 37 formed at a predetermined location rearward of the bearing portion 36, for connection to the second arm 32. Specifically, the first arm rear-side connecting portion 37 has a connecting shaft 37a which extends in the left-right direction with respective opposite ends thereof protruding outward from the left and right side surfaces of the arm body 33. The opposite ends of the connecting shaft 37a are engaged with connecting recesses 45b and 45b of a second arm front-side connecting portion 45, referred to hereinafter, of the second arm 32.

The two weights 34 and 34 formed as elongated and narrow plates are mounted on a weight mounting portion 38, which is a rear portion of the arm body 33, in a state sandwiching the weight mounting portion 38. Note that each weight 34 is made of a material (metal such as iron) having a larger specific gravity than the arm body 33, and is formed e.g., by pressing a metal plate into a predetermined shape.

The second arm 32 is formed as a resin molded article having a predetermined shape by injection molding of the same resin material as that of the arm body 33 of the first arm 31. The second arm 32 is shorter than the first arm 31 and extends a predetermined length in the front-rear direction. Further, the second arm 32 has a bearing portion 41 having a C shape open forward in side view at about a longitudinal center thereof. The bearing portion 41 is pivotally engaged with an associated one of the second pivot shafts 19a of the keyboard chassis 4.

Further, the second arm 32 has a rear portion thereof provided with a second arm rear-side connecting portion 42 connected to the key rear-side connecting portion 23 of the white key 2a. The second arm rear-side connecting portion 42 has a bifurcated shape formed by two left and right connecting arm portions 43 and 43 which extend a predetermined length parallel to each other along the longitudinal direction of the second arm 32. Each connecting arm portion 43 has a rear end thereof formed with a connecting hole 43a extending through the connecting arm portion 43 in the left-right direction. The two connecting arm portions 43 and 43 sandwich the connecting body portion 23a of the key rear-side connecting portion 23 of the white key 2a between the rear ends thereof from the left and the right, and each connecting hole 43a is pivotally fitted on an associated one of the engaging protrusions 23b of the key rear-side connecting portion 23.

Furthermore, the second arm 32 has a front portion thereof provided with the second arm front-side connecting portion 45 connected to the first arm rear-side connecting portion 37 of the first arm 31. The second arm front-side connecting portion 45 has a pair of left and right connecting portions 45a and 45a arranged with a predetermined spacing in the left-right direction. The connecting portions 45a and 45a are each formed with the connecting recess 45b which has a U shape having a slot-like shape in side view and open forward. The left and right connecting portions 45a and 45a of the second arm front-side connecting portion 45 are pivotally and slidably engaged with the respective opposite ends of the connecting shaft 37a of the first arm 31 via the connecting recesses 45b and 45b thereof.

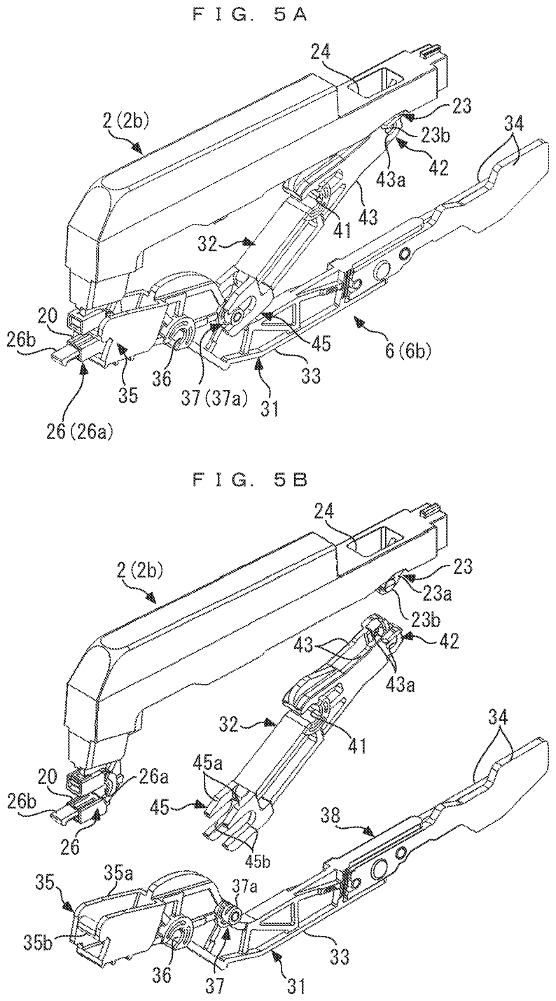

FIG. 5A shows the black key 2b and the key support mechanism 6b therefor on an enlarged scale, and FIG. 5B shows the black key 2b and the key support mechanism 6b in an exploded state. The black key 2b is formed e.g., by injection molding of the same resin material as that of the white key 2a into a hollow shape which extends in the front-rear direction by a predetermined length shorter than that of the white key 2a and opens downward. The black key 2b has a front-side lower end thereof provided with a key front-side connecting portion 26 formed substantially similar to the key front-side connecting portion 22 of the white key 2a. This key front-side connecting portion 26 has a connecting recess 26a which has a U shape having a slot-like shape in side view and open forward. Further, the key front-side connecting portion 26 has an extension portion 26b on a lower-side front end of the connecting recess 26a. The extension portion 26b extends a predetermined length forward of the front surface of the body of the black key 2b. This extension portion 26b functions as an upper limit position regulation portion of the black key 2b. Note that in the following description, the components of the black key 2b and the key support mechanism 6b having the same configurations as those of the above-described white key 2a and key support mechanism 6a are denoted by the same reference numerals and detailed description thereof will be omitted.

The key support mechanism 6b supporting the black key 2b is constructed substantially similar to the above-described white key-associated key support mechanism 6a. Specifically, the arm body 33 of the first arm 31 of the key support mechanism 6b and the second arm 32 of the same are constructed exactly similar in shape and size to the arm body 33 and the second arm 32 of the white key-associated key support mechanism 6a. Note that although the two left and right weights 34 and 34 of the black key-associated key support mechanism 6b are illustrated exactly the same as the weights 34 and 34 of the white key-associated key support mechanism 6a, the shapes and sizes of the weights 34 and 34 of the key support mechanisms 6a and 6b are changed as deemed appropriate according to touch weights and the like required for the keys 2.

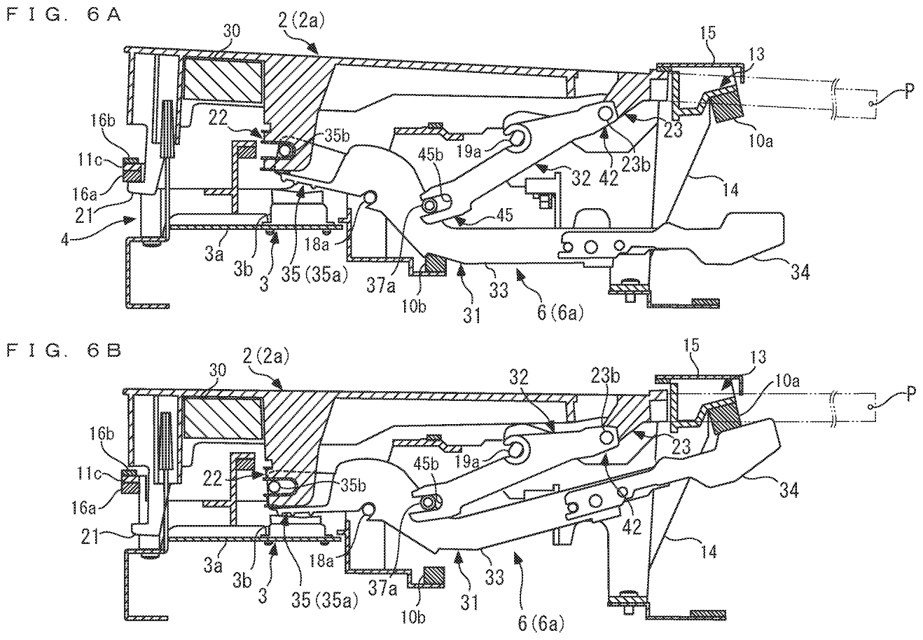

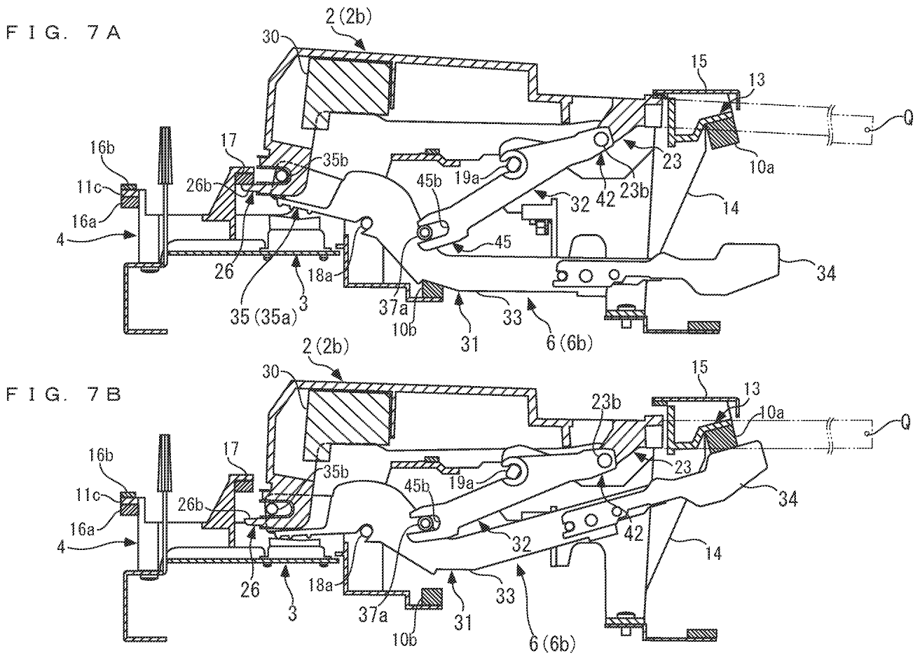

Next, a description will be given of the operation of the keys 2 and the key support mechanisms 6 of the keyboard device 1 constructed as described above. FIGS. 6A and 6B are views useful in explaining the operation of the white key 2a and the key support mechanism 6a associated therewith. FIGS. 7A and 7B are views useful in explaining the operation of the black key 2b and the key support mechanism 6b associated therewith.

When the front end of the white key 2a is depressed by a player with his/her finger from a key-released state shown in FIG. 6A, the key front-side connecting portion 22 of the white key 2a is moved downward, whereby the first arm 31 is pivotally moved in a counterclockwise direction about the first pivot shaft 18a. Further, in accordance with the pivotal movement of the first arm 31, the second arm front-side connecting portion 45, which is engaged with the connecting shaft 37a of the first arm 31 via the connecting recesses 45b and 45b, is moved upward. With this, the second arm 32 is pivotally moved in a clockwise direction about the second pivot shaft 19a. Then, in accordance with this pivotal movement of the second arm 32, the key rear-side connecting portion 23, which is connected to the second arm 32 via the second arm rear-side connecting portion 42 formed at the rear end of the second arm 32, is pulled down, whereby the rear end of the white key 2a is moved downward.

Note that during the above-mentioned pivotal movement of the first arm 31, the box portion 35a of the first arm front-side connecting portion 35 is moved downward, and accordingly, the switch body 3b of one of the key switches 3, which is associated with the depressed key 2, is pressed from above by the bottom wall of the box portion 35a. As a consequence, in the electronic piano, key depression information of the depressed key 2 is detected, and based on the detected key depression information, sound is generated from a speaker, not shown.

As described above, in the case where the white key 2a is depressed, in accordance with the counterclockwise pivotal movement of the first arm 31, the weight 34 of the first arm 31 is inclined such that the weight 34 becomes higher as it extends rearward, whereby the rear end of the weight 34 is brought into contact with the first arm upper limit stopper 10a from below, as shown in FIG. 6B. This prevents further pivotal movement of the first arm 31. When the front end of the white key 2a is depressed to its lowest position, the front end of the white key 2a is brought into contact with the key lower limit stopper 16b, which blocks further depression of the white key 2a.

The white key 2a depressed as described above operates such that it pivotally moves about a virtual pivot P located rearward of the rear end thereof. The location of the virtual pivot P is set such that a distance from the front end of the white key 2a becomes e.g., approximately twice as long as the length of the white key 2a itself. With this, when the front end of the white key 2a is depressed to the lowest position, compared with the case where the white key 2a is in the key-released state shown in FIG. 6A, the front end of the white key 2a is positioned lower by a predetermined key stroke (e.g., 10 mm) and the rear end of the white key 2a is located lower by a distance (e.g., 5 mm) which is approximately half of the predetermined key stroke.

On the other hand, when the finger is released from the white key 2a being depressed, the first arm 31 of the key support mechanism 6a pivotally moves in a direction opposite to the above-mentioned direction, by the own weight of the weight 34, and in accordance therewith, the second arm 32 as well pivotally moves in a direction opposite to the above-mentioned direction. In accordance with this pivotal movement of the second arm 32, the white key 2a pivotally moves upward about the virtual pivot P. Then, a predetermined portion of the first arm 31, rearward of the first pivot shaft 18a, moves into contact with the first arm lower limit stopper 10b from above, and both of the upper limit position regulation portions 21 and 21 of the white key 2a move into contact with the key upper limit stopper 16a from below, whereby further pivotal movement of the white key 2a is blocked and the white key 2a returns to its original key-released state.

Further, operation in response to depression of the black key 2b is performed similar to the above-described operations of the white key 2a and the key support mechanism 6a in response to depression of the white key 2a. More specifically, when a front end of the black key 2b is depressed from a key-released state shown in FIG. 7A, the first arm 31 is pivotally moved in the counterclockwise direction about the first pivot shaft 18a, and the second arm 32 is pivotally moved in the clockwise direction about the second pivot shaft 19a. With this, the black key 2b operates such that it pivotally moves about a virtual pivot Q located rearward of the rear end thereof. Note that similar to the above-mentioned virtual pivot P of the white key 2a, the location of the virtual pivot Q is set such that a distance from the front end of the black key 2b becomes e.g., approximately twice as long as the length of the black key 2b itself. Therefore, when the front end of the black key 2b is depressed to its lowest position, compared with a case where the black key 2b is in the key-released state shown in FIG. 7A, the front end of the black key 2b is positioned lower by a predetermined key stroke and the rear end thereof is positioned lower by a distance which is approximately half of the predetermined key stroke.

On the other hand, when the finger is released from the black key 2b having been depressed, the first arm 31 and the second arm 32 of the key support mechanism 6b pivotally move in respective directions opposite to the above-mentioned directions, and in accordance therewith, the black key 2b pivotally moves upward about the virtual pivot Q. Then, the extension portion 26b of the key front-side connecting portion 26 of the black key 2b moves into contact with the key upper limit stopper 17 from below, whereby further pivotal movement of the black key 2b is blocked, and the black key 2b returns to its original key-released state.

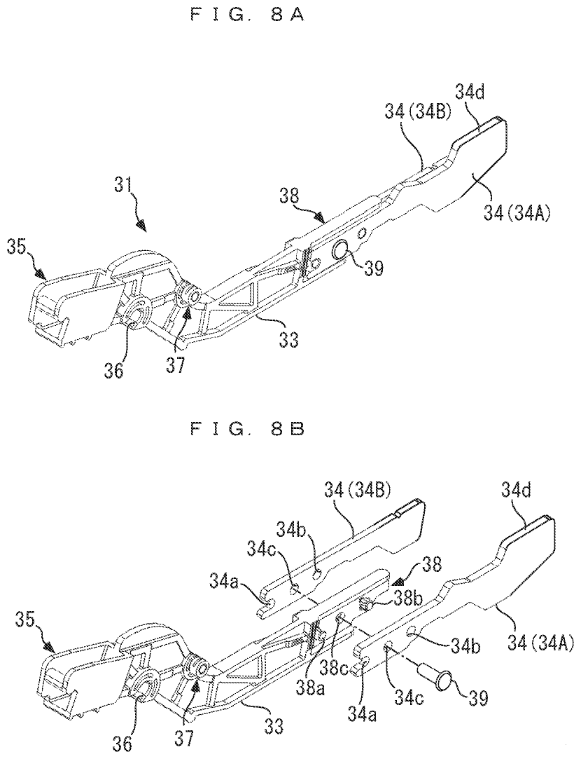

Next, the essential part of the present invention will be described with reference to FIG. 8A to FIG. 10. The essential part of the present invention is a construction of the first arm 31 having a function as a hammer for adding a touch weight to the key 2, in which the first arm 31 has two weights 34 and 34 different in shape from each other, and one weight 34 is formed with a stopper contact portion 34d protruding more upward than the other weight 34.

FIGS. 8A and 8B show the first arm 31. FIG. 8A is a perspective view of the appearance of the first arm 31 and FIG. 8B is an exploded perspective view of the first arm 31 in a state in which the arm body 33 and the two weights 34 and 34 are separated from each other. As described hereinabove, the first arm 31 is comprised of the arm body 33, and the two weights 34 and 34 which are mounted on the weight mounting portion 38 as the rear portion of the arm body 33, in the state sandwiching the weight mounting portion 38. On the weight mounting portion 38 of the arm body 33, at respective predetermined locations of each of opposite left and right side surfaces thereof, there are formed two front-side and rear-side engagement protrusions 38a and 38b protruding outward. Between the front-side and rear-side engagement protrusions 38a and 38b, there is formed a mounting hole 38c extending through the weight mounting portion 38 in the left-right direction.

The two weights 34 and 34 have front halves having the same shape. Specifically, each weight 34 is formed with an engagement recess 34a, an engagement hole 34b, and a mounting hole 34c, which are associated with the front-side engagement protrusion 38a, the rear-side engagement protrusion 38b, and the mounting hole 38c of the arm body 33, respectively. Further, the two weights 34 and 34 are fixed to the arm body 33 in the state sandwiching the weight mounting portion 38 of the arm body 33, by crimping a rivet 39 inserted through the mounting holes 34c, 34c and 38c.

Further, one of the two weights mounted on the first arm 31 (hereinafter referred to as “the common weight 34A”) has a predetermined length and is common to the plurality of first arms 31. Further, the other weight (hereinafter referred to as “the adjustment weight 34B”) is formed to have a length equal to or shorter than that of the common weight 34A.

Note that FIGS. 8A and 8B show the adjustment weight 34B shorter in length than the common weight 34A. Further, it is possible to use the same common weight 34A for all the first arms 31 of the keyboard device 1 or use the same common weight 34A only for first arms 31 in each of predetermined ranges (e.g., a low-pitched sound range, a middle-pitched sound range, and a high-pitched sound range).

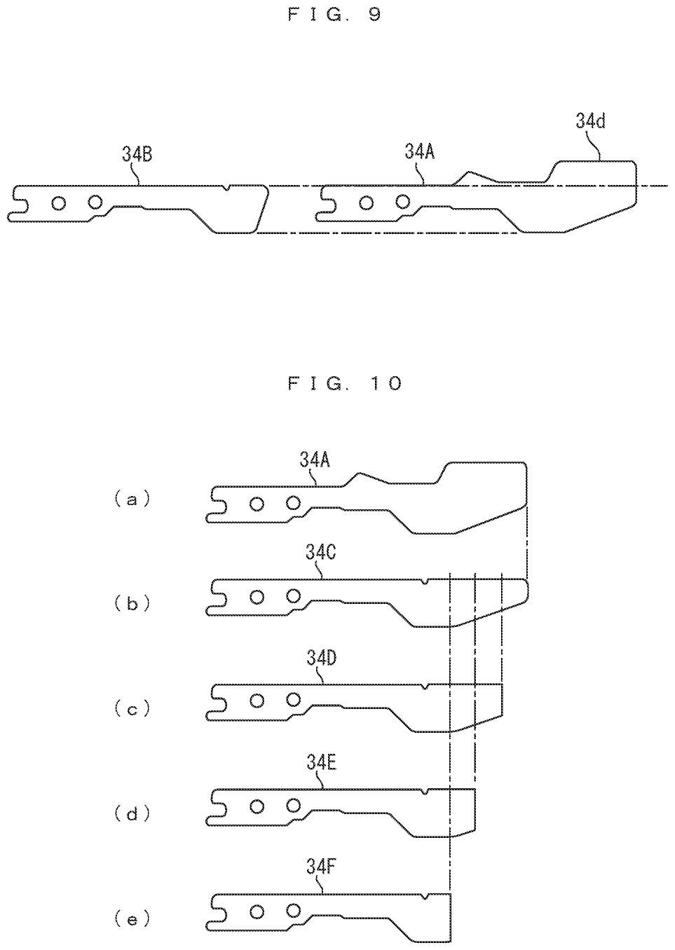

FIG. 9 shows the adjustment weight 34B and the common weight 34A in a horizontally aligned state. As shown in FIG. 9, the common weight 34A has the stopper contact portion 34d provided on a rear portion thereof (right portion in FIG. 9). This stopper contact portion 34d protrudes more upward than an upper surface of the adjustment weight 34B and has an upper surface formed flat. As described heretofore, when the key 2 is depressed, in accordance with the pivotal movement of the first arm 31, the stopper contact portion 34d, which is a rear end of one of the weights 34 and 34, is brought into contact with the first arm upper limit stopper 10a (see FIGS. 6B and 7B). In this case, only the stopper contact portion 34d of the common weight 34A is brought into contact with the first arm upper limit stopper 10a.

FIG. 10 shows the common weight 34A and four adjustment weights 34C to 34F. The common weight 34A and the adjustment weight 34C shown (a) and (b) in FIG. 10, respectively, are set to the same length. On the other hand, the adjustment weights 34D, 34E and 34F shown in (c) to (e), respectively, are shorter in length than the adjustment weight 34C shown (b), and further the lengths of the adjustment weights 34D, 34E and 34F are different from each other. These adjustment weights 34D, 34E and 34F can be easily made as adjustment weights different in weight from each other by preparing the adjustment weight 34C shown in (b) in advance and cutting off respective appropriate rear portions thereof.

As described above in detail, according to the present embodiment, while the common weight 34A is formed common in shape and size to the plurality of first arms 31, the adjustment weight 34B has a length dimension in the front-rear direction set to be equal to or shorter than that of the common weight 34A. By attaching the above-described common weight 34A and adjustment weight 34B to the arm body 33, it is possible to secure not less than half of weight required for each first arm 31 using the common weight 34A and easily adjust the weight required for the first arm 31 using the adjustment weight 34B.

Further, the common weight 34A is provided with the stopper contact portion 34d protruding more upward than the adjustment weight 34B, and out of the first arm 31 which is pivotally moved in interlock with depression of the key 2, the stopper contact portion 34d of the common weight 34A is brought into contact with the first arm upper limit stopper 10a. With this, compared with e.g. a case where both of the common weight 34A and the adjustment weight 34B are brought into contact the first arm upper limit stopper 10a, it is possible to reduce an area brought into contact with the first arm upper limit stopper 10a, whereby it is possible to suppress generation of noise when the first arm 31 is brought into the first arm upper limit stopper 10a. Further, by adjusting the height of the stopper contact portion 34d, it is possible to change timing at which the first arm 31 is brought into contact with the first arm upper limit stopper 10a, whereby it is possible to adjust a key stroke of the key 2.

Further, since the weight of the adjustment weight 34B can be changed by changing the length dimension of the adjustment weight 34B in the front-rear direction, it is possible to easily adjust a touch weight required for the associated key 2 using the total weight of the common weight 34A and the adjustment weight 34B.

Note that the present invention is not limited to the above-described embodiment, but it can be practiced in various forms. Although in the above-described embodiment, the common weight 34A is provided with the stopper contact portion 34d protruding more upward than the adjustment weight 34B (hereinafter referred to as “the upper-side stopper contact portion 34d”), the present invention is not limited to this, but the common weight 34A may be provided with a lower-side stopper contact portion protruding more downward than the adjustment weight 34B, together with the upper-side stopper contact portion 34d. By providing a stopper similar to the above-mentioned first arm lower limit stopper 10b below the common weight 34A, the lower-side stopper contact portion contacts the stopper from above in the key-released state. With this, when the first arm 31 having been pivotally moved in accordance with depression of the key 2 returns to its original key-released state, only the above-described lower-side stopper contact portion is brought into contact with the stopper, and hence it is possible to suppress generation of noise at the time of the contact.

Further, although in the above-described embodiment, the description is given of a case where the length dimension of the adjustment weight 34B in the front-rear direction is set to be equal to or shorter than that of the common weight 34A, the length dimension of the adjustment weight 34B in the front-rear direction can also be set to be longer than that of the common weight 34A depending on the model of the keyboard device or the like.

Further, details of the constructions of the first arm 31, the common weight 34A, and the adjustment weights 34B to 34F shown in the embodiment are given only by way of example, and they can be modified as appropriate within the scope of the subject matter of the present invention.

It is further understood by those skilled in the art that the foregoing are preferred embodiments of the invention, and that various changes and modifications may be made without departing from the spirit and scope thereof.

What is claimed is:

1. A hammer device for a keyboard instrument, which includes a plurality of hammers each provided in association with an associated one of a plurality of keys, and in which each of the hammers is pivotally moved in interlock with depression of the associated key to thereby add a touch weight to the key,
wherein each of the plurality of hammers comprises:
a hammer body extending in a front-rear direction, the hammer body having a front half thereof pivotally supported and a rear half thereof formed with a weight mounting portion;
a first weight extending in the front-rear direction, the first weight being formed common in shape and size to the plurality of hammers, and attached to one of left and right side surfaces of the weight mounting portion; and
a second weight extending in the front-rear direction and attached to the other of the left and right side surfaces of the weight mounting portion, wherein the first weight includes a stopper contact portion protruding at least either more upward or more downward than the second weight, for being brought into contact with a stopper in accordance with pivotal movement of the hammer caused by depression of the key associated therewith.

2. The hammer device according to claim 1, wherein the second weight has a length dimension in the front-rear direction set according to a touch weight required for the associated key.
